(19) United States
(12) Patent Application Publication
(10) Pub. No.: US 2010/0174423 A1
(43) Pub. Date: Jul. 8, 2010

(54) METHOD AND A SYSTEM FOR AUTOMATICALLY MANAGING CHECK LISTS ON AN AIRCRAFT

(75) Inventors: Estelle Pimouguet, Fonsorbes (FR); Nicolas Lambert, Grepiac (FR); Charles Denis, Colomiers (FR); Gregory Perina, Cugnaux (FR)

Correspondence Address: J. Rodman Steele;Novak Druce & Quigg LLP, 525 Okeechobee Blvd, Suite 1500, West Palm Beach, FL, 33401, US

(73) Assignee: AIRBUS OPERATIONS (SAS), Toulouse (FR)

(21) Appl. No.: 12/684,166

(22) Filed: Jan. 8, 2010

(30) Foreign Application Priority Data
Jan. 8, 2009 (FR) 0900045

(51) Int. Cl. G06F 19/00; G01C 21/00

(52) U.S. Cl. 701/3

(57) ABSTRACT

A method and a system for automatically managing check lists on an aircraft.

The system (1) comprises means (8, 12) for determining and presenting the moment when the next check list should be implemented.

The present invention relates to a method and a system for automatically managing check lists on an aircraft, in particular, a transport aircraft.

Within the scope of the present invention, a “checklist” is associated with a particular procedure (a mission or part of a mission) being carried out during a flight, for example, a dropping operation, a low level flight, or an air-to-air refuel for a military aircraft, and such a list enumerates a set of actions that are to be performed within the framework of such a procedure, for example, for preparing or carrying out such a procedure or at the end of the latter.

From FR-2,821,452, a monitoring device is known, having for example as a function to manage check lists, in particular, lists relating to breakdown management that should be carried out upon a breakdown on an on-board system.

Such a known monitoring device is a centralized device of the ECAM (“Electronic Centralized Aircraft Monitoring”) type, which automatically monitors a plurality of systems (engines, control surfaces . . . ) of the aircraft and informs the crew about the condition of such systems. Such a monitoring system comprises for instance:
a unit for monitoring the systems so as to be able to detect a possible breakdown for one of said systems, as well as for managing a set of check lists; and
display means being connected to such a unit and able to display:
   said check lists;
   information relating to the monitoring of the systems; and
   upon a breakdown detection for one of such systems, information relating to such a breakdown, as well as a mode for managing such a breakdown.

Within the framework of the present invention,
carrying out a procedure means performing a task or more generally a set of coherent tasks on board of the aircraft, relating to a mission or part of a mission, such as a dropping operation or an air-to-air refuel for instance;
actions of a check list means performing the actions as being enumerated by such a check list, such actions, for instance fitting out or activating an on-board device, being able to be carried out either manually by a pilot or automatically by the aircraft systems; and
implementing a check list means that a crew member on the one hand checks whether the enumerated actions in such a list have already been performed, and on the other hand, means performing the actions that have not yet been carried out.

Furthermore, it is known that a flight, more particularly a commercial flight of a civil transport aircraft generally proceeds chronologically, from a preparation phase on the ground of the starting airport, until the final standstill on a parking place, on the destination airport. During such a routine flight, the crew usually implements check lists corresponding to predetermined particular procedures, respectively entitled, in a chronological order:
“before start”;
“before start”;
“before take-off”;
“before take-off”;
“approach”;
“landing”;
“after landing”;
“parking”; and
“securing the aircraft”.

Such check lists also exist in other types of flights, more particularly in the military field.

Although not exclusively, the present invention is particularly suited to a tactical flight, i.e. a flight generally implemented in the military field, and comprising at least one tactical event such as an air-to-air refuel, a not preliminarily planned landing, a dropping operation, or troop and/or material parachuting, for instance. Such a tactical flight has a profile which, as a whole, could comprise several high level flight phases and several low level flight phases. A typical profile of such a tactical flight could comprise, for instance, the following successive phases: a take-off phase with an ascent, a high level transit, a fast descent until a low level flight area likely to be hazardous and wherein a tactical event could occur, such as a dropping operation, for instance, and again a high level transit, for example, for air-to-air refuel, and finally a descent down to the final destination.

During such a tactical flight, the crew of a military aircraft could thus be brought to perform numerous tactical missions of different natures, and this, in a non chronological and repeated way. Moreover, such missions could sometimes be interwoven, i.e. partially carried out simultaneously, for instance, a low level flight (first mission) during which a dropping operation (second mission) is carried out.

At various important moments of such tactical missions (generally at the end of the preparation phase and at the end of the mission), the crew must implement check lists, in order to ensure that the set of tactical actions has been correctly carried out. The check lists existing in the tactical field are very numerous, because on the one hand, of the high number of possible missions and on the other hand, of the complexity of such missions. Additionally, for each mission, several check lists should generally be implemented at very precise moments.

Consequently, the crew of an aircraft either military or even civil, is faced with a difficulty to know which check lists are to be implemented during a flight and when such implementations should occur.

In the tactical field, such a difficulty is increased, including in two particular cases:
when missions are interwoven, for example when part of a low level flight mission is carried out in an enemy territory. In such a case, the crew should plan implementing the check lists linked to the flight in an enemy territory and implementing the check lists linked to the low level flight;
when a single check list, or even part of a check list, should be carried out several times cyclically, for example in the case of a series of air-to-air refuel operations carried out by a single refuelling aircraft.

In general, pilots write down on paper cards the moments during the mission when the different check lists are to be implemented. Such a solution is however little satisfactory, as it requires, on the one hand, that the pilot regularly looks up his cards, preventing him from completely and fully concentrating on the on-going mission. On the other hand, even if he can thus know the moment of the mission when a check list should be carried out, he still does not know exactly at which level of the mission he is exactly. Consequently, such a usual solution for managing check lists is not satisfactory, especially in the military field.

The present invention aims at overcoming such drawbacks. It relates to a method for automatically managing check lists on an aircraft, allowing for instance to automatically advise the crew of the aircraft about the moment when each check list should be implemented.

To this end, according to this invention, said method using an automatic management device comprising:
a unit for managing a set of check lists, said unit knowing for each check list the state thereof (complete implementation or lack of complete implementation) and a limit time information (for the implementation); and
display means being connected to said unit and able to display at least said check lists,
   is remarkable in that:
a) the set of procedures to be carried out during the flight of an aircraft is defined; and
b) automatically and repeatedly, during the flight:
   b1) common values of parameters (velocity, level, . . . ) of the aircraft are determined, illustrating a common performance of said aircraft;
   b2) from the procedures to be carried out, limit time information are determined relating to those check list associated with such procedures, being received from said unit, and the aircraft common performance, at least the moment when the next check list is to be implemented, the implementation of a check list comprising, for the set of actions enumerated in such a list, checking whether those actions have already been carried out, and carrying them out should this not be the case; and
   b3) there is presented to at least one crew member of the aircraft, through information means, each moment determined this way in step b2).

Thus, through the invention, there is presented to a crew member, in particular to the pilot of the aircraft, the moment when, during the flight, at least the next check list should be implemented. Thus, he exactly knows at which moment he should implement such a next check list (and he further knows that he does not have to implement another check list before such a moment). Moreover, using said display means, he is able to know exactly (including on request) those actions that are enumerated in the check list that should be implemented.

Consequently, the pilot of an aircraft is always advised when a check list should be implemented, avoiding him to have to concentrate on managing such lists, and to carry out particular tasks, such as writing down on paper cards the different implementation moments.

Moreover, as the steps b1, b2 and b3 of the method according to this invention are automatically carried out, the pilot's and the other crew members' work load is decreased.

In a preferred embodiment, at step b2), the moments for implementing the set of check lists (that are to be implemented during the flight) are determined and, at step b3), all those moments are shown, further indicating for each corresponding check list whether it has already been implemented or not. Thus, the pilot globally knows about the set of the check lists to be implemented during the flight. Moreover, he exactly knows which ones have already been implemented (and which ones have not been implemented yet).

In a particular embodiment:
at step a) a flight plan that should be followed during the flight is generated;
at step b1) the common position of the aircraft is determined;
at step b2) for each already determined moment (for check list implementation), an associated estimated position corresponding to the position reached by the aircraft at said moment if it follows said flight plan with its common performance is calculated; and
at step b3) a navigation screen shows a path representing said flight plan, on which there are displayed, more particularly, a first symbol illustrating the common position of the aircraft and, for each estimated position calculated at step b2), a second symbol illustrating such an estimated position.

Thus, a correlation is achieved between navigation information (flight plan; first symbol) being generally displayed on a navigation screen and information (second symbols) relating to check lists being partially available on an automatic management device. Consequently, watching the navigation screen, the pilot exactly knows the position of his aircraft and the distance thereof with respect to the (estimated) positions along the flight plan, to which check lists should be implemented. He is thereby able to anticipate the checks to be carried out, allowing to make managing said check lists easier. Moreover, advantageously:
for each check list, there is automatically checked whether it has been implemented at an associated limit time; and
if it has not been implemented at such an associated limit time, a warning signal, either of the sound and/or visual type, is automatically emitted.

In addition, advantageously:
a plurality of systems (engines, control surfaces, . . . ) of the aircraft is further monitored, so as to be able to detect a breakdown of one of said systems;
upon detecting a breakdown of one of said systems, at least one auxiliary check list is determined, enumerating a set of postponed actions to be subsequently carried out, during the flight, because of the breakdown; and
at least said steps b2) and b3) are implemented for such an auxiliary check list.

The present invention further relates to a system for automatically managing check lists on an aircraft, in particular, a transport aircraft.

According to this invention, said automatic management system of the type comprising an automatic management device comprising:
a unit for managing a set of check lists, said unit knowing for each check list the state thereof and a limit time information; and
display means being connected to said unit and able to display at least said check lists,
   is remarkable in that it further comprises:
first means for supplying the set of procedures to be carried out during a flight of the aircraft;
second means for determining automatically and repeatedly, during the flight, common values of the parameters of the aircraft, illustrating the common performance of said aircraft;
third means for determining automatically and repeatedly, from the procedures to be carried out, received from said first means, limit time information relating to the check lists associated with those procedures, received from said unit and the common performance of the aircraft, received from said second means, at least the moment when the next check list should be implemented, the implementation of a check list comprising, for the set of actions enumerated in such a list, checking whether those actions have already been carried out and carrying them out should this not be the case; and
fourth means for automatically presenting to at least one crew member of the aircraft, each moment determined by said third means.

In a particular embodiment, said third means comprise a first element for automatically checking, for each check list, whether it has been implemented at an associated limit time, and a second element for automatically transmitting information corresponding to said automatic management system (preferably to said automatic management device of said system) if a check list has not been implemented at the limit time thereof, and said automatic management system further comprises means for emitting a warning signal in such a situation.

Additionally, advantageously, said system according to this invention further comprises:
means for monitoring systems (engines, control surfaces, . . . ) of the aircraft so as to be able to detect a breakdown in one of said systems; and
means for determining, upon detecting a breakdown, at least one auxiliary check list enumerating a set of postponed actions to be subsequently carried out, during the flight, because of the breakdown, said auxiliary check list being processed at least by said third and fourth means of said automatic management system as any check list.

Furthermore, in a preferred embodiment:
said automatic management device is part of a central warning system of the FWS (“Flight Warning System”) type of the aircraft; and
said third means are part of a flight management system of the FMS (“Flight Management System”) type of the aircraft, said first means representing means (keyboard, control ball, . . . .) allowing a crew member to enter data into said flight management system.

Said system for automatically managing check lists according to this invention offers a valuable aid to the crew of an aircraft regarding planning check lists, delegating to on-board means the task involving time anticipating and managing such check lists. Such an automatic management system more particularly provides some safety against forgetting check lists. It keeps the crew aware of the check lists that have already been implemented, should a check list have been forgotten, the crew is automatically advised by an appropriate warning signal.

The present invention further relates to an aircraft comprising a system for automatically managing check lists, such as the above mentioned one.

The figures of the appended drawing will make it well clear how this invention could be carried out. In the figures like reference numerals relate to like components.

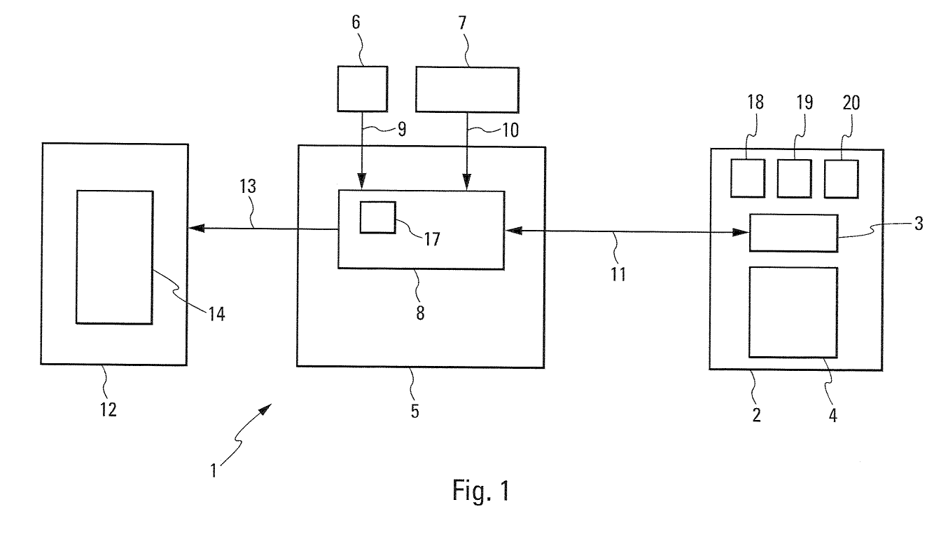

FIG. 1 is the block diagram of an automatic management system according to this invention.

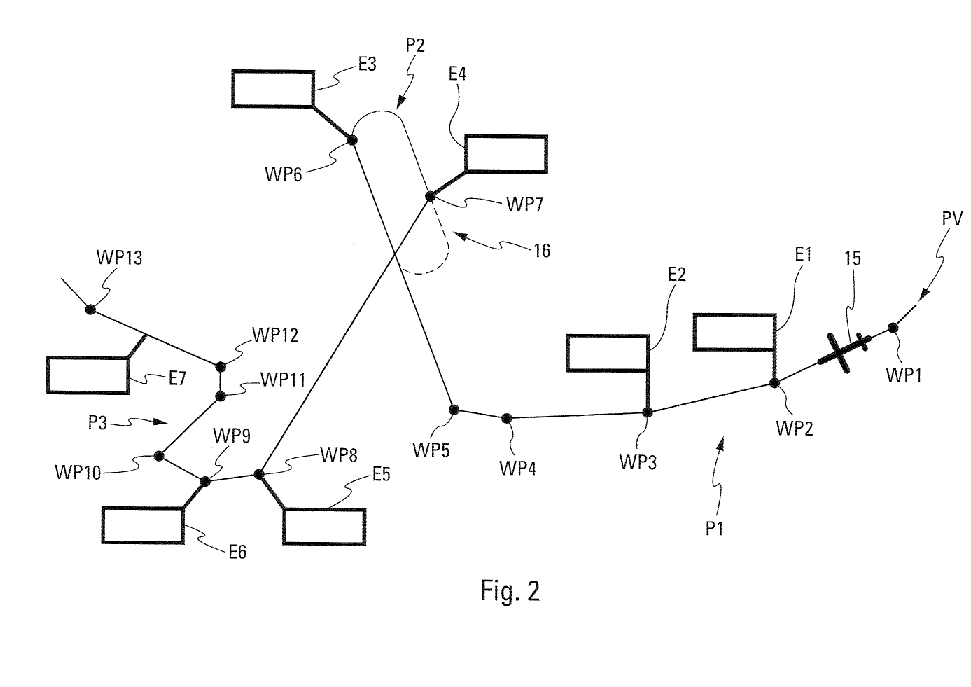

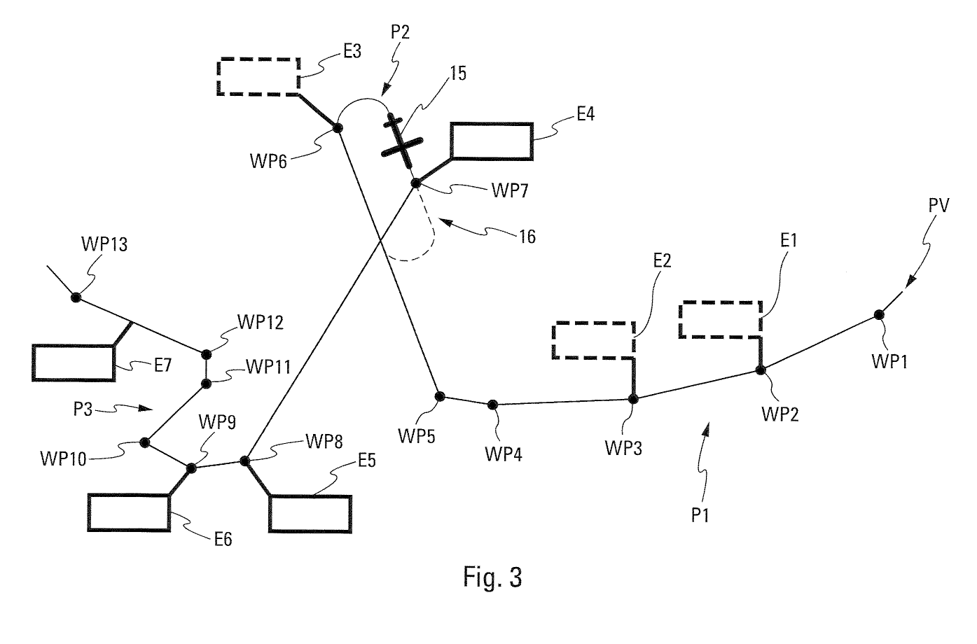

FIGS. 2 and 3 schematically illustrate two displays implemented by a system according to this invention, at two different moments of a mission of an aircraft.

The system 1 according to this invention and schematically represented on FIG. 1 is provided for automatically managing check lists on an aircraft (not shown), in particular, a transport airplane.

Within the framework of the present invention, a check list is associated with a particular procedure (mission or part of a mission) being carried out during a flight, for example a dropping operation, a low level flight or an air-to-air refuel for a military airplane, and such a list enumerates a set of actions to be carried out within the framework of such a procedure.

Said system 1 comprises an automatic management device 2, usually comprising:
a unit 3 for managing a set of check lists. Said unit 3 knows, more particularly, for each check list, the state thereof [implemented (if it has already been implemented at the common instant) or not implemented (if it has not been implemented yet)] and a limit time information regarding the implementation thereof; and
display means 4, able to display at least said check lists, i.e. the complete list of actions to be carried out.

Said device 2 could be any device able to automatically manage check lists. However, in a preferred embodiment, such an automatic management device 2 is a central warning system of the FWS (“Flight Warning System”) type, wherein the display means thereof 4 represent a screen of the SCAM (“Electronic Centralized Aircraft Monitoring”) type. In such a preferred embodiment, the unit 3 comprises usual means 19 for monitoring the systems of the aircraft, such as engines, control surfaces and/or lighting, for example, so as to be able to detect a possible breakdown of one of said systems, and said display means 4 are able to display:
information relating to monitoring such systems; and
upon detecting a breakdown of one of said systems, information relating to such a breakdown, as well as a mode for treating such a breakdown.

According to this invention, said system 1 further comprises:
means 6 for providing the set of procedures to be carried out during a flight of the aircraft. Such means 6 could comprise usual means, such as a keyboard and/or a designator associated with a screen for example, allowing a crew member, in particular, the pilot of the aircraft, to enter such information into said system 1;
a set 7 of information sources, comprising usual means allowing to automatically determine and this repeatedly during the flight, the common values of the parameters of the aircraft, such as its velocity, its mass, its level, . . . Within the framework of the present invention, the set of such common values allows to define usually the common performance of the aircraft;
means 8 being connected through links 9, 10 and 11 respectively to said means 6 and 7 and to said device 2 and being formed so as to automatically determine repeatedly (from the procedures to be carried out, received from said means 6, limit time information relating to the check lists associated with such procedures, received from said unit 3 of the device 2; and the common performance of the aircraft, received from said set 7) at least the moment when the next check list should be implemented. Implementing a check list comprises, for the set of actions enumerated in such a list, checking whether such actions have already been carried out and carrying them out should this not be the case; and
means 12 being connected through a link 13 to said means 8 and being formed so as to automatically present to at least one crew member of the aircraft each moment determined by said means 8, as stated hereinbelow.

Thus, the system 1 according to this invention presents to a crew member in particular, to the pilot of the aircraft, the moment when, during the flight, at least the next check list should be implemented (amongst the plurality of check lists to be implemented during such a flight). Thus, the pilot (or another crew member) exactly knows the moment when he should implement such a next check list (and that he will not have to implement any other check list before such a moment). Additionally, via said display means 4, he is able to know exactly the actions being enumerated in such a check list.

Consequently, the pilot of an aircraft is always advised when a check list should be implemented, avoiding him to have to concentrate on managing lists, and to carry out particular tasks, such as writing down on paper cards implementation moments.

Besides, as the system 1 comprises an automatic management of check lists, the pilot's work load is highly reduced.

In a particular embodiment, said means means 8 determine the implementation moments for the set of check lists (that should be implemented during the flight) and said means 12 simultaneously present all those moments, further indicating whether the corresponding check list has already been implemented or not.

Thus, the pilot globally knows about the set of the check lists to be implemented during the flight. Moreover, he exactly knows which ones have already been implemented (and which ones have not been implemented yet).

Furthermore, in a preferred embodiment:
said means 6 are formed so as to allow a crew member to enter a usual flight plan PV into the system 1. Such a flight plan PV must be followed by the aircraft during the flight;
said set 7 comprises usual means for determining the common position of the aircraft;
said means 8 being, for example, part of a flight management system of the FMS (“Flight Management System”) type calculate, for each already determined moment (of implementation of a check list), an associated estimated position corresponding to the position reached by the aircraft at said moment if it follows said flight plan PV with its common performance (received from the set 7); and
said means 12 comprise a usual navigation screen 14 of the ND (“Navigation Display”) type.

Such means 12 show on said navigation screen 14, as shown on FIGS. 2 and 3:
a path PV representing said flight plan, entered by means 6. In the part of the flight plan PV as shown on FIGS. 2 and 3, the latter comprises a plurality of waypoints WP1 to WP13;
a symbol 15 illustrating the common position of the aircraft on said path PV; and
for each estimated position, calculated by said means 8, a symbol E1, E2, . . . , E7 illustrating such an estimated position on said path PV. Each of such symbols E1 to E7 is represented, preferably, in the form of a label, wherein there is indicated the title of the corresponding check list.

In the example of FIGS. 2 and 3, the aircraft is a military transport airplane, performing a flight, during which it should carry out three particular procedures P1, P2 and P3 respectively corresponding to:
a low level flight between waypoints WP2 and WP3;
an air-to-air refuel as illustrated by a circuit 16; and
a dropping (or parachuting) operation of goods and/or troops, between waypoints WP10 and WP11.

In the example of FIGS. 2 and 3, a plurality of particular check lists are to be implemented as illustrated by labels E1 to E7, respectively corresponding to:
for label E1, the entry of the low level flight (“LLF Entry”: LLF for “Low Level Flight”);
for label E2, at the exit of the low level flight (“LLF Exit”);
for label E3, the air-to-air refuelling before contact (“AAR before contact”: AAR for “Air-to-Air Refuel”);
for label E4, the air-to-air refuelling during flight after transfer (“AAR after transfer”);
for label E5, the preparation of a drop (“Drop preparation”);
for label E6, a pre-drop (“Pre-drop”); and
for label E7, the situation after drop (“After drop”).

Preferably, the navigation screen 14 achieves a different representation of labels E1 to E7, depending on whether the corresponding check lists have already been implemented or not. When a check list has not been implemented yet, the corresponding label is symbolized by a first representation, for example, a blue rectangle, being illustrated on FIGS. 2 and 3 by a solid line rectangle. On the contrary, when a check list has been implemented, the corresponding label is symbolized by a second representation, for example a brown rectangle, being illustrated on FIG. 3 by par a broken line rectangle (for labels E1, E2 and E3).

In the situation on FIG. 2, the aircraft is located between waypoint WP1 and point WP2 (corresponding to the starting point of phase P1 of the low level flight). Consequently, the aircraft has not performed the above mentioned flight phases P1, P2 and P3 yet, and the check lists as designated by labels E1 to E7 have not been implemented yet. Thus, such labels E1 to E7 are symbolized by the first representation (solid line). In contrast, in the situation of FIG. 3, the aircraft is located between waypoints WP6 and WP7, on the circuit 16. It is performing the air-to-air refuel phase 2. Consequently, the check lists located upstream its common position have already been implemented and the corresponding labels E1, E2 and E3 are thus symbolized by the second representation (broken line), whereas labels E4 to E7 located downstream this common position in the flight direction are symbolized by the first representation, the corresponding check lists having not been implemented yet.

As a consequence, in this preferred embodiment, the system 1 achieves a correlation between navigation information (symbol 15, path PV) being in general displayed on a navigation screen 14 and information (labels E1 to E7) relating to such check lists being determined from available data on an automatic management device 2. Consequently, watching the navigation screen 14, the pilot exactly knows the position of his aircraft (symbol 15) and the distance thereof with respect to the positions (along the flight plan PV), where the check lists should be implemented. He can thereby anticipate implementing such checks, allowing for the management thereof to be easier and simplified.

Furthermore, in a particular embodiment, said means 8 comprise an element 17 for automatically check, for each check list, whether it has been implemented in an associated limit time, being transmitted to it through the link 11 by the device 2. If such an element 17 of means 8 detects that a check has not been implemented at its associated limit time, the system 1 automatically emits a warning signal.

In an alternative preferred embodiment, said means 8 inform the device 2 via the link 11 should a lack of implementation be detected in the time limits of a check list, and said device 2 then emits a visual warning signal, for example on a visualization screen and more particularly, on display means 4, and/or a sound warning signal, for example via corresponding warning means 18.

Such a warning signal could also be emitted by other warning means (not shown) of said system 1.

The system 1 according to this invention could also display information relating to check list, in particular to the check lists remaining, on other display means and, especially, on screens already existing on the aircraft, such as, for example, on a head-up display of the HUD (“Head-Up Display”) type and/or on an on-board information system of the OIS (“On-board Information System”) type.

Furthermore, in a particular embodiment, said device 2 further comprises:
means 19 for monitoring a plurality of systems of the aircraft, such as engines, control surfaces and/or lighting, so as to be able to detect a breakdown of one of said systems; and
means 20 for usually determining at least one auxiliary check list, upon detecting a breakdown on said systems. Such an auxiliary check list usually enumerates a set of postponed actions to be subsequently carried out, during the flight, carrying out such actions being caused by the breakdown occurring.

In this particular embodiment, the device 2 provides such an auxiliary check list to said means 8 (via the link 11), as for a usual check list. In such a case, the system 1 according to this invention processes this auxiliary check similarly to the other check lists, more particularly by determining and indicating the moment thereof when it should be implemented and, in the case of the alternative embodiment as shown on FIGS. 2 and 3, displaying a corresponding label on the flight plan PV illustrated on the navigation screen 14.

Said system 1 for automatically managing check lists, according to this invention, thus provides a valuable help to the crew of the aircraft regarding planning such check lists, delegating to means of the aircraft the task involving time anticipating and managing such check lists. Such an automatic management system 1 provides some additional safety against forgetting check lists. It keeps the crew aware of the check lists that have already been implemented, and, should a check list have been forgotten, the crew is automatically advised by an appropriate warning (visual and/or sound) signal.

Besides, said automatic management system 1 according to this invention can be applied both to the civil field and to the military field.

1. A method for automatically managing check lists on an aircraft, a check list being associated with a particular procedure and enumerating a set of actions to be performed within the framework of such a procedure, said method using an automatic management device (2) comprising:
a unit (3) for managing a set of check lists, said unit (2) knowing for each check list the state thereof and a limit time information; and
display means (4) being connected to said unit (2) and able to display at least said check lists, wherein:
a) the set of procedures to be carried out during the flight of the aircraft is defined; and
b) automatically and repeatedly, during the flight:
b1) the common values of parameters of the aircraft are determined, illustrating common performance of said aircraft;
b2) from the procedures to be carried out, limit time information are determined relating to those check lists associated with such procedures, being received from said unit (3), and the aircraft common performance, at least the moment when the next check list is to be implemented, the implementation of a check list comprising, for the set of actions enumerated in such a list, checking whether those actions have already been carried out, and carrying them out should this not be the case; and
b3) there is presented to at least one crew member of the aircraft, through information means (12), each moment determined this way at step b2).

2. The method according to claim 1, wherein step b2) the moments when the set of check lists should be implemented during the flight are determined and at step b3) such moments are presented, further indicating for each corresponding check list whether it has already been implemented or not.

3. The method according to claim 1, wherein:
at step a) a (PV) flight plan that should be followed during the flight is generated;
step b1) the common position of the aircraft is determined;
step b2) for each already determined moment of check list implementation, an associated estimated position corresponding to the position reached by the aircraft at said moment if it follows said (PV) flight plan with its common performance is calculated; and
step b3) a navigation screen (14) presents a path (PV) representing said flight plan, onto which there are displayed a first symbol (15) illustrating the common position of the aircraft and, for each estimated position calculated at step b2), a second symbol (E1 to E7) illustrating such an estimated position.

4. The method according to claim 1, wherein:
for each check list, there is automatically checked whether it has been implemented at an associated limit time; and
if it has not been implemented at such an associated limit time, a warning signal is automatically emitted.

5. The method according to claim 1, wherein:
a plurality of systems of the aircraft is further monitored, so as to be able to detect a breakdown in one of said systems;
upon detecting a breakdown in one of said systems, at least one auxiliary check list is determined, enumerating a set of postponed actions to be subsequently carried out, during the flight, because of the breakdown; and
at least said steps b2) and b3) are implemented for such an auxiliary check list.

6. A system for automatically managing check lists on an aircraft, a check list being associated with a particular procedure and enumerating a set of actions to be performed within the framework of such a procedure, said automatic management system (1) comprising an automatic management device (2) comprising:
a unit (3) for managing a set of check lists, said unit (3) knowing for each check list the state thereof and a limit time information; and
display means (4) being connected to said unit (3) and being able to display at least said check lists, further comprising:
first means (6) for providing the set of procedures to be carried out during a flight of the aircraft;
second means (7) for determining automatically and repeatedly, during the flight, common values of the parameters of the aircraft, illustrating the common performance of said aircraft;
third means (8) for determining automatically and repeatedly, from the procedures to be carried out, received from said first means (6), limit time information relating to the check lists associated with those procedures, received from said unit (3) and the common performance of the aircraft, received from said second means (7), at least the moment when the next check list should be implemented, the implementation of a check list comprising, for the set of actions enumerated in such a list, checking whether those actions have already been carried out and carrying them out should this not be the case; and
fourth means (12) for automatically showing to at least one crew member of the aircraft, each moment determined by said third means (8).

7. The system according to claim 6, wherein said third means (8) comprise a first element (17) for automatically checking, for each check list, whether it has been implemented at an associated limit time and a second element for automatically transmitting a corresponding information to said automatic management system (1) if a check list has not been implemented at the limit time thereof, and in that said automatic management system (1) further comprises means (4, 18) for emitting a warning signal in such a situation.

8. The system according to claim 6, further comprising:
means (19) for monitoring systems of the aircraft so as to be able to detect a breakdown in one of said systems; and
means (20) for determining, upon detecting a breakdown, at least one auxiliary check list enumerating a set of postponed actions to be subsequently carried out, during the flight, because of the breakdown, said auxiliary check list being processed at least by said third and fourth means (8, 12) of said automatic management system (1) as any check list.

9. The system according to claim 6, wherein:
said automatic management device (2) is part of a central warning system of the aircraft; and
said third means (8) are part of a system for managing a flight (5) of the aircraft, said first means (6) representing means allowing a crew member to enter data into said flight management system.

10. An aircraft, comprised of a system (1) for automatically managing check lists, according to claim 6.
